(19) United States
(12) Patent Application Publication
(10) Pub. No.: US 2005/0253735 A1
(43) Pub. Date: Nov. 17, 2005

(54) Portable traffic light

(76) Inventor: Milton Johnson, Decatur, GA (US)

Correspondence Address: Milton Johnson, 2288 Wallingford DR, Decatur, GA, 30032, US

(21) Appl. No.: 10/730,833

(22) Filed: Apr. 27, 2004

(51) Int. Cl. G08G 1/095

(52) U.S. Cl. 340/908

(57) ABSTRACT

The “Portable Traffic Light” is a standard light that include a housing for securing the units to support three separate bulb housings; separating the red, yellow, and green signal components, with electrical power to each unit that allow the signals to operate. Each electrical connection is programmed to allow each color unit to change in sequence; red, yellow, green—green, yellow and red. The uniqueness of the portable unit allows the light to be removed or placed at locations when needed due to outages, thus allowing very low down-time; thereby greatly reducing accidents and confusion as to the right of way. The total unit is light weight (10 to 12 pounds) and is transported by police, fire and emergency personnel. The battery pack, equipped with computer chip and connectors to the unit provide the power to operate the system. A hook atop the unit allows it to be moved and placed where needed when outages occur.

### BACKGROUND OF INVENTION

The present invention relates to a traffic control device with the sole purpose of eliminating traffic related problems due to outages that interrupt traffic flow.

### References Cited

U.S. PATENT DOCUMENTS

| | | |
|---|---|---|
| 2,718,635 | September 1955 | Sabiers |
| 3,401,234 | September 1968 | Heald |
| 3,930,226 | December 1975 | Plumberg |
| 4,009,535 | March 1977 | Stock |
| 4,017,825 | April 1977 | Pickey |
| 4,857,921 | August 1989 | McBride |
| 4,777,751 | October 1988 | Pasquate |

### DESCRIPTION OF PRIOR ART

This light does not destract from our present control devices, which will be readily recognized when an area is affected by outages. This will most certainly cause less or very little interruption in traffic flow, thus practically eliminating most accidents due to outages.

Various devices exist in prior art. Example U.S. Pat. No. 6,107,941, issued to James, relates to a traffic control system having a center light housing and a pair of outer light housings on opposite sides.

U.S. Pat. No. USD-438,810S, issued to Chun Hue Liao relates to an ornament design for a warning lantern for carriageway.

U.S. Pat. No. 6,118,388 issued to Morrison relates to a portable traffic light with a rectangular base with wheels to roll the device from place to place. The light may be operated with a remote control device. U.S. Pat. No. 6,150,957 issued to Henz, relates to a traffic control device used to warn approaching motorists to areas of road construction or repair.

### SUMMARY OF INVENTION

The present invention relates to a traffic control device that virtually eliminate traffic related problems due to accidents, power outages, construction at intersections, and any weather related problems. The light is equipped with the standard red, yellow and green signal devices that allow amper time for traffic movement in either direction.

### DESCRIPTION OF DRAWINGS

FIG. 1 is a view of the battery power cell that supplies the power to operate the signal unit. The cell can be recharged and used as a substitute power supplier when conditions require.

FIG. 2 is the unit with computer components that are programmed to regulate the operations of the device. The unit is equipped with LED(light emission diodes), with timed elements to regulate the signal changes. The portability allows the unit to be used in immediate affected areas.

### DETAILED DESCRIPTION OF THE INVENTION

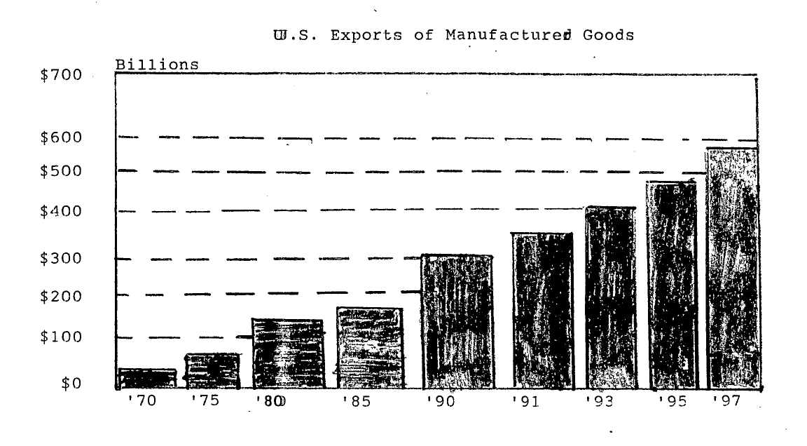

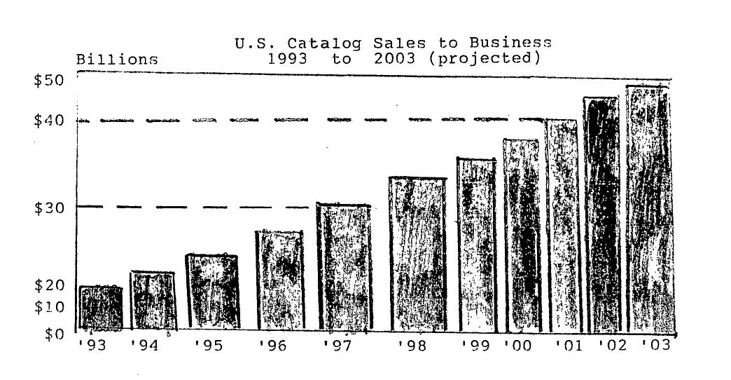

Referring to FIG. 1, the battery pack or power pack is a rechargeable unit with reserve power to provide extended use of the unit. Many outages take days to repair thus the power unit allows a virtual non-interruption in an affected area thereby reducing possible accidents and outages, consequently reducing insurance costs and claims.

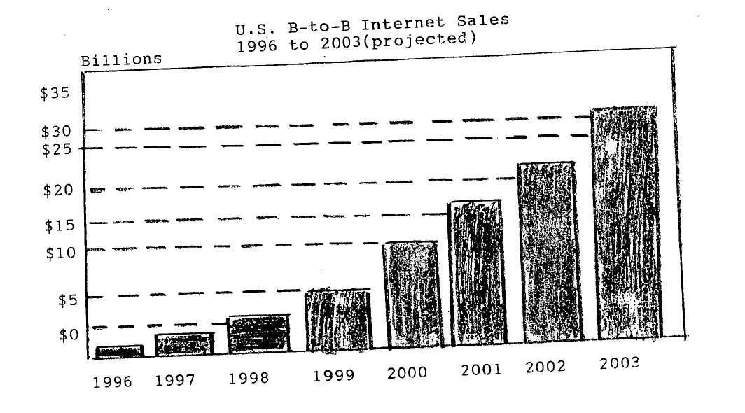

The unit (FIG. 2) controls the signal changes the same as standard light signal controls. Once the unit is programmed, there is an immediate solution to traffic interruptions. Intersections are cleared up; police presence is not required; no confusion as to the right of way. And an overall reduction in traffic related accidents. While the unit will have to be retrieved by police, fire or traffic control engineers, it will certainly cut down on the down time of repairing an affected area.

In 1997 . the value of U.S. exported goods totaled $689.18 billion, of which $592.5 billion, or 86 percent, was manufactured goods. Canada is by far America's highest volume trading partner, accounting for $151.77 billion of U.S. exports. Mexico imported $71.39 billion in U.S. goods; Japan, $65.55 billion; the United Kingdom, $36.43 billion; South Korea, $25.05 billion; and Germany, $24.46 billion. Nine additional countries imported more than $10 billion in American goods: Taiwan, Netherlands, Singapore, France, Hong Kong, Belgium, China, Brazil, Australia, and Malaysia. The value of exports to these nations totaled $140.59 billion.

Distribution Channels:

Once the potential market targets for a new product have been identified, consideration should be given to identifying the types of outlets where the product could potentially be distributed to those market targets. In obtaining the number of outlets for a particular distribution channel, we utilize information provided in the Census of Retail Trade, the Census of Wholesale Trade, and the Census of Service Industries.

The following channels represent potential outlets where “Portable Traffic Light” could be distributed:

| | |
|---|---|
| Wholesale of Safety Products and Supplies: | 2,132 |
| Wholesale Distributors of Contractors' | 11,111 |
| Equipment and Supplies (inc. manufacturers): | |
| Merchant Wholesalers of Miscellaneous | 4,360 |
| Commercial Equipment | |
| Agents, Brokers, and Commission Merchants of | 488 |
| Miscellaneous Commercial Equipment: | |

Distribution to the international market would involve selected exporters as Indicated below:

| | |
|---|---|
| Wholesale Merchant Exporters of | 56 |
| Miscellaneous Commercial Equipment | |
| Wholesale Merchant Exporters of | 414 |
| Transportation Equipment and Supplies: | |

Direct Marketing to Business:

In addition to mainstream wholesale outlets, “Portable Traffic Light” could also be distributed by mail order catalog, Internet commerce, and/or other direct marketing initiatives to business.

Direct marketing to business resulted in an estimated $612.2 billion in sales in 1998, and represented 45 percent of total sales generated by direct marketing initiatives that year.

The Direct Marketing Association (DMA) reports that U.S. business spent $82.6 billion marketing directly to other businesses in 1998, resulting in $174.7 billion in sales from direct orders, $393.1 billion in sales from generated leads, and $44.4 billion sales from generated in-store traffic. American firms spent the most for telephone marketing in their business-to-business direct market expenditures, which accounted for $39.2 billion, or 47 percent, of total spending. Direct mail accounted for $15.0 billion, or 18 percent, of direct marketing expenditures in 1998.

The DMA projects that total expenditures for business-to-business direct marketing initiatives will grow an average of 7.4 percent annually during the next few years, reaching $118.3 billion in 2003. Spending for business-to-business Internet marketing is projected to reach $4.86 billion. The DMA expects sales resulting from these two direct marketing segments to reach $31.17 billion and $47.13 billion, respectively, as total sales from business-to-business initiatives reach $974.9 billion in 2003.

I. A substitute control device to immediately remedy traffic related problems.

II. Will free up the manhours of policemen, firemen, traffic engineers and provide times for their services elsewhere due to time involvement at intersections where there is no control.

III. Control or eliminate traffic accidents.

IV. Lower the cost of insurance. (statistics show that when outages occur, there is a higher incidence of traffic related accidents and claims).

V. Control pedestrians movement by creating a safety zone when power is interrupted
